(19) United States
(12) Patent Application Publication
(10) Pub. No.: US 2026/0057625 A1
(43) Pub. Date: Feb. 26, 2026

(54) System

(71) Applicant: Softbank Group Corp., Tokyo (JP)

(72) Inventor: Toru Kikuchi, Tokyo (JP)

(21) Appl. No.: 19/302,208

(22) Filed: Aug. 18, 2025

(30) Foreign Application Priority Data
Aug. 21, 2024 (JP) 2024-140459

(51) Int. Cl. G06T 19/20; G06F 40/279; G06T 19/00

(52) U.S. Cl. CPC G06T 19/20; G06F 40/279; G06T 19/006

(57) ABSTRACT

A system includes a processor that is configured to acquire text information, convert the acquired text information into an image or a video, customize the image or video based on user profile information, and transmit the customized image or video to a user's visual device.

### CROSS-REFERENCE TO RELATED APPLICATION

This application claims priority under 35 USC 119 from Japanese Patent Application No. 2024-140459 filed Aug. 21, 2024, the disclosure of which is incorporated by reference herein in its entirety.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Individuals with dyslexia or certain visual impairments face significant challenges in comprehending textual information in their daily lives and educational activities. Conventional assistive technologies often fail to provide adequate support for understanding text-rich information, especially when such information is encountered in real-world environments or in complex documents. There remains a need for a system that can dynamically convert textual information into accessible visual content, personalized to the user's specific needs and preferences, and deliver such content to various types of visual devices.

### SUMMARY

The present invention provides a system including a processor that acquires text information, converts the acquired text information into an image or a video, customizes the image or video according to user profile information, and transmits the customized image or video to a user's visual device. The system is capable of utilizing optical character recognition (OCR) technology for acquiring text information and supports delivery of the customized content to augmented reality devices or virtual reality devices, thus enabling users with dyslexia or related impairments to visually comprehend the textual information in a more accessible format.

“Processor” means a hardware or software component capable of executing instructions and performing operations necessary to acquire, convert, customize, and transmit information within the system.

“Text information” means data consisting of characters, words, or sentences that can be acquired from printed or digital sources.

“Acquire” means the process of obtaining or capturing text information from an image, document, or other source.

“Convert” means changing the form of text information into another format, specifically into an image or a video.

“Image” means a visual representation, such as a picture or graphic, generated from text information.

“Video” means a sequence of visual frames, which may include motion or animation, generated from text information.

“Customize” means modifying or adapting the image or video based on specific characteristics or preferences of a user, including but not limited to visual accessibility requirements.

“User profile information” means stored data describing a user's personal characteristics, preferences, or accessibility needs relevant to the presentation of visual content.

“Transmit” means sending the customized image or video from the system to a user's visual device using a communication medium.

“Visual device” means hardware capable of displaying images or videos to a user, including augmented reality (AR) devices or virtual reality (VR) devices.

“Optical character recognition (OCR) technology” means a process or tool used to recognize and digitize printed or handwritten text from an image.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions; and

FIG. 10 illustrates an emotion map mapping plural emotions.

FIG. 11 is a sequence diagram showing the flow of data processing system processing in Example 1.

FIG. 12 is a sequence diagram showing the flow of data processing system processing in Application Example 1.

FIG. 13 is a sequence diagram showing the flow of data processing system processing in Example 2.

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

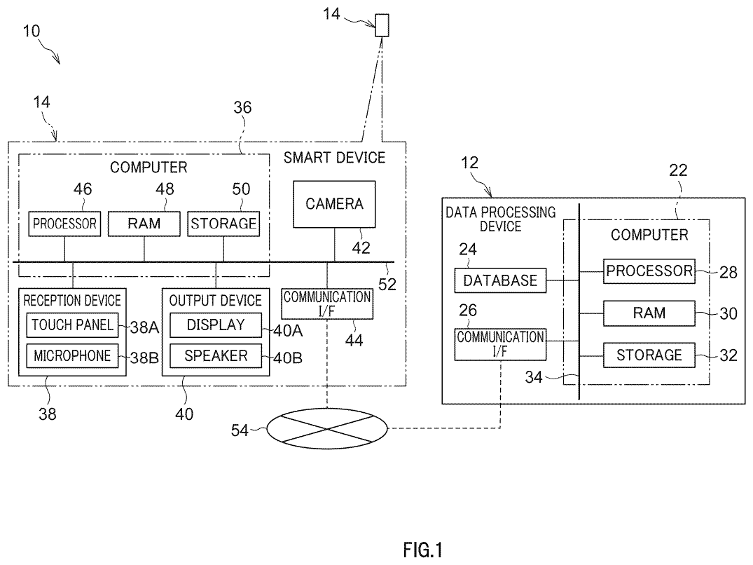

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

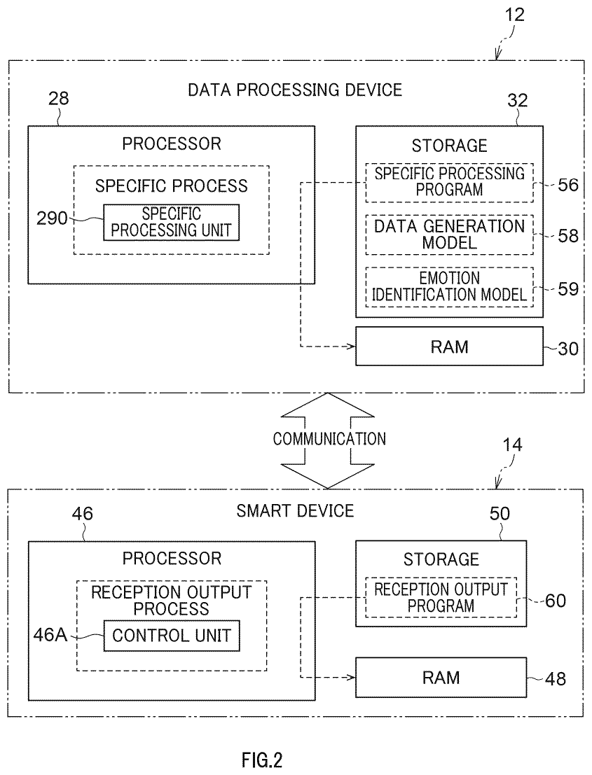

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In everyday life and educational environments, users with reading difficulties such as dyslexia often encounter challenges in visually recognizing and understanding textual information presented in physical or digital formats. Conventional solutions do not efficiently convert textual information into forms that are both visually accessible and tailored to the diverse needs of individual users, particularly in real time and across various contexts. There remains a need for a system that can automatically acquire textual data, analyze and process it, and generate customized visual representations optimized for each user's abilities and preferences.

The specific processing by the specific processing unit 290 of the data processing device 12 in Example 1 is realized by the following means.

The present invention provides a server including a processor configured to acquire data information, perform optical recognition processing to extract character string data, conduct syntactic analysis on the extracted data, convert the analyzed data into visually recognizable visual representation data using a generative artificial intelligence model, adjust the visual representation based on user information, transmit the adjusted visual data to an information presentation device, and generate and adjust a prompt sentence for input to the generative artificial intelligence model. This enables users, including those with reading difficulties, to access customized, visually optimized representations of textual information in real time, thereby improving accessibility, comprehension, and usability of information in daily life.

The term “processor” refers to a hardware or software computational unit capable of executing programmed instructions to perform data processing tasks within a system.

The term “data information” refers to information including text, images, or other digital content that can be acquired and processed by the system.

The term “optical recognition processing” refers to a technique that analyzes image data to detect and extract character string data, such as using optical character recognition technologies.

The term “character string data” refers to sequences of alphanumeric or other textual symbols extracted from image data or digital inputs.

The term “syntactic analysis” refers to the computational process of analyzing the grammatical and structural properties of character string data to identify syntax, sentence structure, and meaning.

The term “generative artificial intelligence model” refers to a machine learning or artificial intelligence algorithm that generates new data or content, such as images or formatted visual outputs, based on input data and prompt instructions.

The term “visually recognizable visual representation data” refers to image or video data transformed or generated to enhance human visual perception and understanding, particularly for users with specific accessibility requirements.

The term “user information” refers to data that represents user-specific profiles, preferences, settings, needs, or accessibility requirements that influence how information is presented.

The term “components” refers to individual elements or parts of the visual representation data, such as textual elements, symbols, icons, or color attributes.

The term “display format” refers to the structural layout, arrangement, and presentation style used in displaying the visual representation data.

The term “color scheme” refers to the combination of colors and their arrangements applied for presenting the visual representation data in a visually accessible manner.

The term “emphasis” refers to any technique or adjustment used to highlight or distinguish certain elements within the visual representation data, such as bold text, increased size, or color highlighting.

The term “display attributes” refers to the visual properties and parameters, including color, size, contrast, and arrangement, that affect how visual representation data is perceived. The term “information presentation device” refers to a user-facing hardware device, such as a display, augmented reality device, or virtual reality headset, capable of presenting visual representation data to the user.

The term “prompt sentence” refers to an instruction or query generated for input to the generative artificial intelligence model, guiding the model to produce specific types of visual representation data in accordance with user needs.

An embodiment for implementing the invention will be described in detail below.

The server includes a processor configured to acquire data information, such as digital images containing textual content. The processor may be implemented using general-purpose computing equipment, including cloud servers or dedicated processors. The data information can be obtained by the terminal, which may be a smartphone, tablet, or eyewear-type device such as augmented reality (AR) or virtual reality (VR) displays.

The terminal captures an image of the desired text using its embedded camera and uploads the image to the server through a network connection. The terminal may utilize commercially available optical recognition processing software, such as image-based text extraction libraries or cloud-based OCR services, to convert the image data into character string data before transmission. For example, the terminal may use an image capture application and an OCR application programming interface to recognize and extract the text from the image.

Upon receiving the character string data, the server processes the data by applying syntactic analysis, utilizing software frameworks such as Python-based libraries that are capable of parsing sentence structure, understanding parts of speech, and analyzing the logical relationships within the text. This enables the server to understand the grammatical features and semantic content necessary for subsequent steps.

The server then generates a prompt sentence designed to instruct a generative artificial intelligence model to produce visually recognizable visual representation data. The prompt sentence incorporates both the extracted text and attributes specific to the user's needs, which may be stored as user information in a profile database. For example, the prompt sentence can specify preferences for font size, color scheme, emphasis on particular text, or background color adjustments suitable for color vision deficiencies. The generative artificial intelligence model can be a machine learning model such as a transformer-based large language model or a generative adversarial network, implemented using standard frameworks like TensorFlow or PyTorch, and may be hosted on cloud infrastructure.

The generated visual representation data is then adjusted by the server based on the user's profile information. Adjustment involves modifying components, display format, color scheme, emphasis, and other display attributes of the generated image or video to meet the individual requirements of the user. Image or video processing software, such as the Python Imaging Library or OpenCV, may be used for this customization.

Finally, the server transmits the adjusted visual representation data to the information presentation device, which can include AR glasses, VR headsets, computer monitors, or mobile devices. The user receives and views the customized visual output in real time, allowing for improved readability and comprehension of textual information regardless of physical or cognitive limitations.

A concrete example is as follows: The user uses a smartphone camera to capture a street sign. The terminal uses optical recognition processing to extract the text and transmits it to the server. The server analyzes the syntax of the text, generates a prompt sentence such as, “Please create an image that makes the following street sign text easily understandable for a user with dyslexia. The preferred font size is large, and the background should be blue,” and inputs this prompt into the generative artificial intelligence model. After the image is generated, the server adjusts the image based on user profile information and sends it to the AR glasses worn by the user, allowing the user to visually perceive the street sign information according to their needs.

Another example involves a student who uses a tablet to scan a textbook page. The server processes the extracted text, formulates a prompt sentence like, “Generate a high-contrast visual summary of the following paragraph with large, bold font suitable for easy recognition by users with reading difficulties,” and uses the generative artificial intelligence model to produce the image, which is then adjusted and presented on the student's VR headset.

Example prompt sentences for the generative AI model include the following: “Transform the following extracted text into an easy-to-understand infographic. The user profile: prefers blue background, large fonts, and bold keywords.”

“Make a visual summary of this sentence for a person with dyslexia. Highlight nouns in red and ensure high contrast.”

In this way, the system ensures that any user, regardless of their visual or cognitive ability, can access customized, accessible, visual representations of textual information in real-time environments.

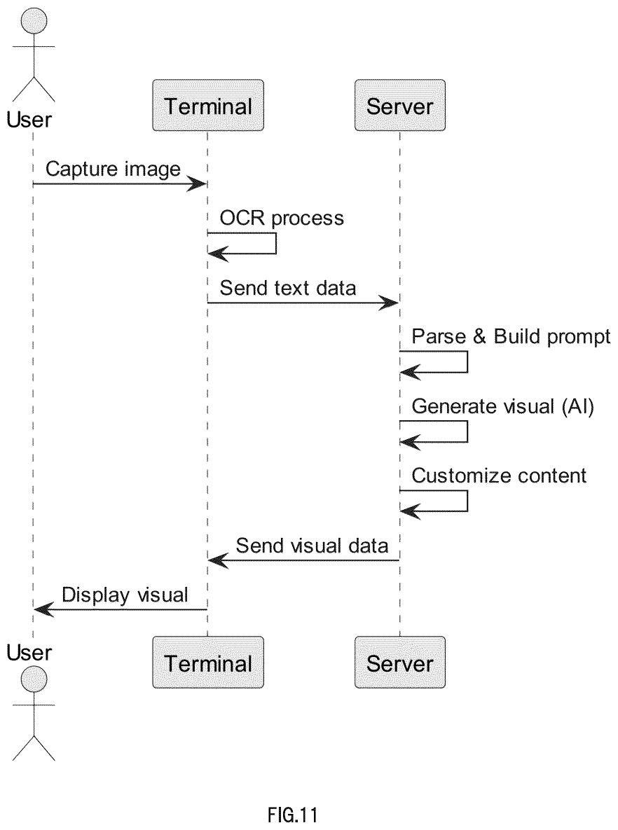

The following describes the processing flow using FIG. 11.

### Step 1:

The user activates a dedicated application on the terminal, such as a smartphone or AR glasses, and uses the device's camera to capture an image containing the textual information of interest (for example, a street sign or a page of a book).

Input: Physical object containing text (e.g., street sign, book page)

Data processing: The terminal initiates the device camera, saves the captured image file, and may display a notification confirming a successful capture.

Output: Captured image data stored on the terminal device

### Step 2:

The terminal applies optical recognition processing (OCR) to the captured image in order to extract the embedded character string data from the visual data.

Input: Captured image data

Data processing: The terminal utilizes an OCR library or cloud-based OCR API to detect and recognize text within the image, generating digital character string data. The terminal may also identify the position and structure of the recognized text within the image.

Output: Extracted character string data (digital text) and optional positional metadata

### Step 3:

The terminal transmits the extracted character string data, along with relevant metadata (such as image context or user ID), to the server over a secure network connection.

Input: Extracted character string data and metadata

Data processing: The terminal formats the data into a structured request and sends it via an HTTP request to the server endpoint. The terminal displays a progress indicator or disables further input while transmission is ongoing.

Output: Data package received by the server

### Step 4:

The server receives and parses the transmitted data, then performs syntactic analysis on the character string data to identify grammatical structure and meaning.

Input: Character string data from the terminal

Data processing: The server uses a syntactic analysis library to parse sentences, identify parts of speech, and extract semantic information. Any transmission errors are logged or reported.

Output: Parsed and structured text data suitable for further processing

### Step 5:

The server generates a prompt sentence for use with a generative AI model, combining the parsed text data with user profile information (such as display preferences or accessibility needs).

Input: Parsed text data and user profile information

Data processing: The server constructs a prompt sentence containing both the extracted content and detailed customization instructions based on the user's stored profile.

Output: Formulated prompt sentence tailored for the generative AI model

### Step 6:

The server inputs the prompt sentence and parsed text data to the generative AI model, which processes this data and generates a visually recognizable visual representation (image or structured graphic).

Input: Prompt sentence and parsed text data

Data processing: The server communicates with the generative AI model (for example, via an API call) and receives generated visual content.

Output: Newly generated visual representation data (e.g., image file)

### Step 7:

The server customizes the generated visual content based on user-specific information, modifying display format, color scheme, emphasis, and other display attributes according to the user's profile.

Input: Generated visual representation data and user profile information

Data processing: The server applies further processing, such as adjusting color palettes, resizing fonts, or adding emphasis, using image processing libraries.

Output: Customized visual representation data adapted for the individual user

### Step 8:

The server transmits the customized visual representation data to the terminal or information presentation device, such as AR glasses, VR headsets, or a mobile device screen. Input: Customized visual representation data

Data processing: The server sends the data over a secure connection, and the terminal receives and renders the content, optionally providing user feedback upon completion.

Output: Customized visual content displayed on the user's information presentation device

### Step 9:

The user views the presented visual representation of the original text information and, if necessary, interacts with the terminal to adjust settings (such as zoom or contrast) or request further clarifications.

Input: Customized visual content displayed on the presentation device

Data processing: The user interprets the information and may use interface controls provided by the terminal to refine the display.

Output: Improved user understanding and accessibility for the original text information

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional systems often fail to provide users with reading difficulties, such as dyslexia or low vision, an effective way to understand textual information in real world environments. Existing approaches do not sufficiently convert and optimize textual data from physical objects, such as product labels or signage, into easily accessible visual content tailored to individual user needs and preferences. There is a need for a system that dynamically extracts, analyzes, and visually delivers such information in a user-optimized, real-time manner via wearable or mobile display devices.

The specific processing by the specific processing unit 290 of the data processing device 12 in Application Example 1 is realized by the following means.

The present invention provides a server including a processor configured to acquire data from an information acquisition apparatus, extract character data, analyze the meaning of the extracted character data using a natural language processing model, generate visual data by inputting a generation instruction sentence to a generative AI model based on the analyzed character data and user attribute information, individually optimize the generated visual data according to user attribute or user state information, and transmit and present the optimized visual data to a display device. This enables users, including those with reading or visual disabilities, to intuitively and efficiently understand textual information from real-world objects via tailored visual content on wearable or mobile devices.

The term “information acquisition apparatus” refers to a hardware device capable of obtaining data from physical environments, such as a camera-equipped wearable device, a smartphone, or any sensor-capable terminal.

The term “character data” refers to digitally represented textual content that is extracted from acquired data, including but not limited to letters, numbers, and symbols. The term “natural language processing model” refers to a computational system or algorithm that analyzes, interprets, and derives meaning from character data using machine learning or artificial intelligence techniques.

The term “generative AI model” refers to a computational model that can generate new data, such as images or videos, based on input instructions or prompts and learned examples, including but not limited to models based on Generative Adversarial Networks or transformer architectures.

The term “generation instruction sentence” refers to a structured input text or prompt provided to a generative AI model to guide the creation of output data in a desired manner. The term “user attribute information” refers to data describing characteristics or preferences of the user, such as visual acuity, reading ability, display preferences, or accessibility requirements.

The term “user state information” refers to real-time data indicating the user's current condition, such as emotional state, attention level, or stress, obtained through monitoring devices or sensors.

The term “visual data” refers to electronically generated image or video content created to visually communicate information extracted and processed from the original data.

The term “display device” refers to an electronic apparatus capable of presenting visual data to the user, including but not limited to wearable displays, augmented reality devices, virtual reality headsets, or handheld terminals.

The term “optical character recognition technology” refers to a software or hardware-based system that extracts and digitizes textual information from images, photographs, or scanned documents.

One embodiment of the invention will now be described in detail, including the structure, operation, and practical usage of the system, with reference to the technical features described in the claims.

The system includes an information acquisition apparatus, such as a wearable device with a built-in camera, a mobile terminal like a smartphone, or a tablet computer. The terminal acquires data in the form of real-world images that include textual information, such as product labels, signage, books, or other printed materials. The terminal is configured to use optical character recognition (OCR) technology, specifically software such as Tesseract OCR, to process the acquired image and extract character data.

The terminal is also equipped with communication means, such as a wireless or wired network module, to transmit the extracted character data to a server. The server includes a processor and associated memory, where advanced software modules are executed to further process and analyze the received character data.

Upon receiving character data from the terminal, the server applies a natural language processing (NLP) model—such as BERT or GPT (General Purpose Transformer)—to analyze and interpret the character data, extract semantic information, and determine the context and structure of the text.

The server then generates a generation instruction sentence (prompt sentence), which is an input formulated based on the analyzed character data and user attribute information, such as the user's visual or cognitive characteristics, preferences, or accessibility requirements.

Using this generation instruction sentence, the server utilizes a generative AI model, such as a Generative Adversarial Network (GAN) or DALL-E, to create visual data in the form of an image or video. This visual data is designed for optimal accessibility by incorporating user-specific customization, such as adjusting font sizes, color schemes, highlighting keywords, or altering layout based on user attribute information or user state information, like emotional or attentional state.

After generation and customization, the server transmits the optimized visual data to a display device. The display device can be an augmented reality headset, a virtual reality headset, or a standard display module integrated into a wearable or mobile device. The user receives the visual data in real time on the display device. The optimized content allows the user, including those with reading difficulties such as dyslexia or low vision, to intuitively and efficiently understand the textual information present in the user's environment.

For example, when a user at a retail store wants to read a product label, the user operates the terminal to capture an image of the label. The terminal extracts the text, such as “Detergent, Yen750 Special Price!”, and sends it to the server. Upon receiving the character data, the server analyzes the text with a natural language processing model, generates a generation instruction sentence such as:

“Transform the following product label into an accessible visual for dyslexic users, highlighting discounts in red and displaying price in large font. Text: “Detergent, Yen750 Special Price!”

The generative AI model then creates a visual that displays the product name in large, easy-to-read text, the price in an even larger size, and the discount announcement highlighted visually, for example, in red. The content may be further optimized for the user's needs and sent back to the display device worn by the user, allowing immediate and accessible comprehension.

This embodiment may use various hardware such as imaging sensors, mobile computing devices, wearable displays, and a networked server system. Software components include, but are not limited to, Tesseract OCR for text extraction, BERT or GPT for language analysis, and GAN or DALL-E for visual generation. The described system thus provides a comprehensive and interactive solution to the real-world accessibility problem faced by users with reading or vision difficulties.

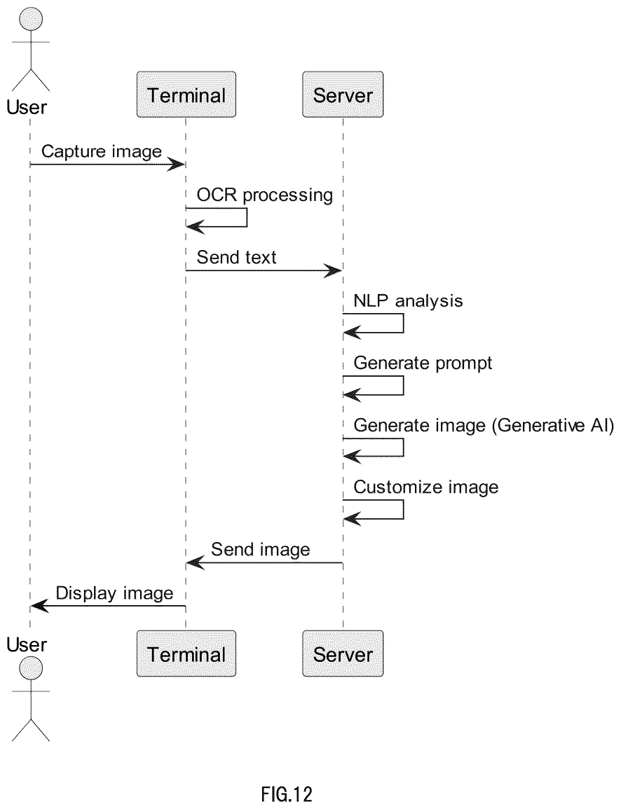

The following describes the processing flow using FIG. 12.

### Step 1:

User operates the terminal, such as a smart glasses device or smartphone, to capture an image of real-world textual information (e.g., a product label or sign). The input is a physical object or text in the environment, and the output is a digital image file stored in the terminal. The user points the camera at the target and presses a capture button.

### Step 2:

Terminal loads the captured image file and executes an optical character recognition module, such as Tesseract OCR, to extract character data from the image. The input is the digital image, and the output is machine-readable character data. The terminal processes the image pixels and recognizes letters, numbers, and symbols.

### Step 3:

Terminal establishes a secure network connection and transmits the extracted character data to the server. The input is the character data, and the output is a network message containing the character data sent from the terminal to the server. The terminal serializes the data into a suitable format (e.g., JSON) for transmission.

### Step 4:

Server receives the character data, then applies a natural language processing model such as BERT or GPT to analyze the text for meaning and structure. The input is the transmitted character data, and the output is parsed and annotated text information, including semantic labeling or extraction of key elements. The server interprets product names, prices, and other contextual data.

### Step 5:

Server generates a prompt sentence based on the parsed text and the stored user attribute information. The input is the processed text and user profile information, and the output is a customized prompt sentence that describes the accessibility needs and the context for visual data generation. The server constructs an instruction such as “Render the following text with enlarged price and highlight discounts in red.”

### Step 6:

Server utilizes a generative AI model, such as a Generative Adversarial Network or DALL-E, to create visual data (image or video) by submitting the generated prompt sentence. The input is the prompt sentence, and the output is visual content tailored to accessibility requirements. The server invokes the model with the prompt and obtains a visual representation.

### Step 7:

Server further customizes the visual content using user attribute information or user state information, such as emotional state or color vision deficiency. The input is the generated visual data and user-specific data, and the output is an individually optimized visual image or video. The server modifies attributes like font size, color scheme, or layout.

### Step 8:

Server transmits the optimized visual data to the terminal via a network connection. The input is the optimized visual image or video, and the output is a network message received by the terminal. The server encodes the file and pushes it to the corresponding user session.

### Step 9:

Terminal receives the optimized visual data and displays it on the device screen, such as a transparent AR display or mobile device. The input is the received visual data, and the output is the visual presentation observable by the user. The terminal loads the content and overlays or presents it for immediate user access.

### Step 10:

User views and interprets the visually optimized information presented on the device. The input is the visual image or video displayed, and the output is the user's comprehension or informed decision based on the accessible content. The user can now easily understand the original real-world textual information regardless of reading difficulty.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems for generating visual content from textual information primarily focus on straightforward conversion without adequately considering the individual visual characteristics or emotional states of users. As a result, it is difficult for users with specific needs, such as those with dyslexia, visual impairments, or sensory sensitivities, to efficiently and comfortably understand textual information presented in daily life or educational environments. Furthermore, there is insufficient flexibility to dynamically optimize visual content based on real-time user feedback, such as emotional stress or changing preferences. There is a need for a system that can provide personalized and emotionally adaptive visual content corresponding to diverse user profiles and conditions.

The specific processing by the specific processing unit 290 of the data processing device 12 in Example 2 is realized by the following means.

The present invention provides a server including a processor configured to acquire character information, extract and digitize the character information through a recognition process, analyze the digitized information through a semantic analysis process, convert the character information into visual information data using a generative artificial intelligence model based on a prompt sentence, individually adjust the visual information based on user attribute information, analyze the emotional state of a user based on facial or voice information, optimize the visual information according to the analysis result, and transmit the optimized visual information data to a display device. This enables personalized and adaptive visual content presentation that effectively addresses the individual visual and emotional needs of users, thereby improving information comprehension and user experience.

The term “character information” refers to data including letters, symbols, or text that is to be interpreted or processed by the system.

The term “recognition process” refers to a procedure that detects and digitizes character information from a medium, such as an image, using optical or computational techniques.

The term “semantic analysis process” refers to an analysis procedure for understanding the meaning, structure, and context of digitized character information by applying natural language processing technologies.

The term “generative artificial intelligence model” refers to a machine learning model capable of generating new data, such as images or video, from input data based on learned patterns, including models such as generative adversarial networks and diffusion models.

The term “prompt sentence” refers to an instruction or descriptive statement provided as input to a generative artificial intelligence model to guide the nature of the content to be generated.

The term “visual information data” refers to image or video data that visually represents the results of processing the character information.

The term “user attribute information” refers to data representing personal characteristics, preferences, or needs of an individual user that influence how information should be presented.

The term “facial information” refers to biometric data derived from analysis of a user's facial expression or features captured through imaging devices.

The term “voice information” refers to audio data capturing the sounds, tone, or speech patterns produced by a user, collected via audio sensors or microphones. The term “emotional state” refers to the psychological or affective condition of a user, such as stress, comfort, interest, or focus, as determined from biometric or behavioral input.

The term “display device” refers to any electronic hardware capable of visually presenting information to a user, including but not limited to augmented reality devices, virtual reality devices, and general-purpose screens.

The term “optical recognition process” refers to a data acquisition technique that utilizes optical or imaging technologies, such as optical character recognition, to identify and extract character information from physical sources.

One embodiment for implementing the invention described in the claims is as follows:

The system includes a processor implemented on a server, one or multiple client terminals, and various types of display devices, such as augmented reality devices, virtual reality devices, and general-purpose screens. The user operates the terminal, which may include a smartphone, AR glasses, or a VR headset, to capture character information-such as text from printed material, signboards, or electronic media-using an imaging device (for example, an embedded camera). The system utilizes optical recognition processes, such as those performed by optical character recognition (OCR) software (for example, commonly available OCR libraries or APIs), to detect and digitize character information from the captured images.

After digitization, the server receives the recognized character information and performs semantic analysis using natural language processing (NLP) software modules, such as a syntactic analysis engine, entity recognition model, and context extraction tools. This process often involves commercially available or open-source NLP toolkits. The processor then constructs or selects a prompt sentence based on the semantic analysis result, user attributes, and current context.

The processor invokes a generative artificial intelligence model (for example, a generative adversarial network [GAN], a diffusion model, or an equivalent system), providing the constructed prompt sentence as input. The generative AI model produces visual information data, such as images or videos that represent the processed character information. Software frameworks for implementing the generative AI model may include popular machine learning platforms such as TensorFlow, PyTorch, or other suitable environments.

Further, the server retrieves user attribute information from its user database. This information may include the user's preferences, visual sensitivity, color perception, font size needs, and other characteristics. The visual information data generated by the AI model is then customized using image processing libraries or equivalent APIs (such as PIL or OpenCV) to satisfy the user's specific attributes.

To increase adaptability, the terminal collects biometric input, such as facial images or voice audio, which is then transmitted to the server. The server analyzes the user's emotional state by processing this biometric data using an emotional analysis engine based on machine learning or rule-based algorithms. Depending on the outcome, the server optimizes the visual information data-such as by altering color tones, adjusting visual complexity, or modifying pacing-so that the final display content is emotionally appropriate and comfortable for the user.

The optimized visual information data is then transmitted from the server to the user's display device. The user receives and interacts with the visual content tailored to their cognitive, perceptual, and emotional needs. This cycle enables the system to continually present information that is both accessible and engaging, even for users with special requirements such as dyslexia or visual impairments.

As one example, when a user wants to read a difficult sign in a public space, the user points their smartphone at the sign. The terminal uses OCR to recognize the sign's text, sends the result to the server, which performs semantic analysis and constructs a prompt sentence-such as “Create a dyslexia-friendly image representing ‘Central Park Entrance’ for a user who prefers large font and blue tones.” The generative AI model generates an image accordingly, and the server customizes it based on the user's profile and real-time emotional state (for instance, relaxing the color palette if the user appears stressed). The resulting image is displayed to the user through the device, ensuring the content is both accessible and comfortable to perceive.

Another example occurs in an educational setting, where a student uses the system to extract information from a textbook page. The terminal captures the page, performs OCR, and the server generates a sequence of illustrations supporting the core concepts in the text, customized for visual clarity, learning goals, and emotional comfort.

Example prompt sentences used for the generative AI model include:

“Generate a visual guide for ‘Central Park Entrance’, using dyslexia-friendly fonts and a calming blue background. Emphasize clarity for a user who feels stressed.”

“Using a generative adversarial network, convert the following text to a visual scene suitable for a visually sensitive user: ‘Biology Lesson: Structure of a Plant Cell.’ Keep colors muted and maximize font size.”

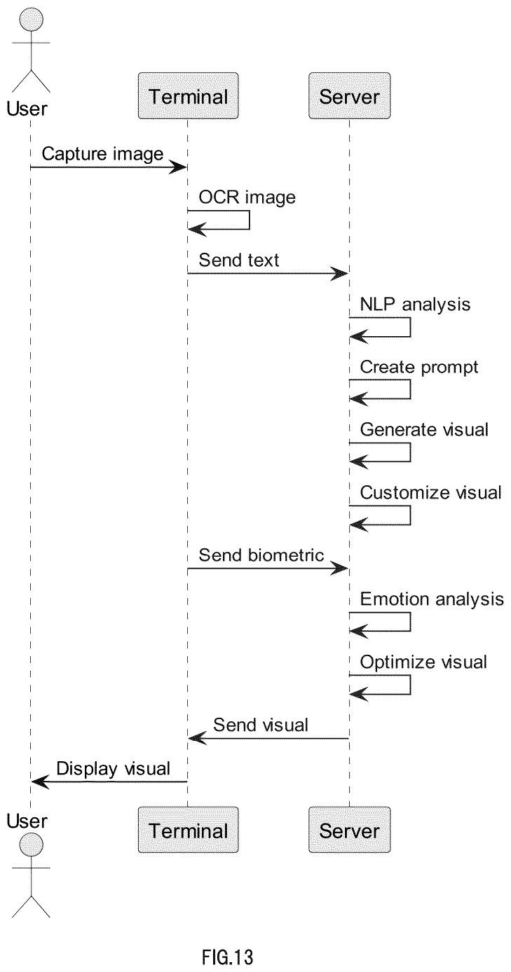

The following describes the processing flow using FIG. 13.

### Step 1:

User operates the terminal, such as a smartphone or AR/VR device, to capture an image containing character information. The input is a real-world object or document with text; the output is an image file captured by the terminal's camera. The user launches a designated application and captures a photo of a sign, book page, or screen.

### Step 2:

Terminal processes the captured image using optical character recognition (OCR) software to extract character information. The input is the image file from Step 1; the output is digitized text data representing the recognized characters. The terminal may enhance the image by adjusting contrast and cropping before running the OCR.

### Step 3:

Terminal validates the recognized text for errors, compresses the text data, encrypts it, and transmits it to the server through a secure connection. The input is the digitized text from Step 2; the output is an encrypted, compressed payload sent to the server. The terminal uses data validation, compression algorithms (such as gzip), and a secure transmission protocol (like HTTPS).

### Step 4:

Server receives and decrypts the text data, then stores it in a user-specific area of a database. The input is the encrypted and compressed data from Step 3; the output is the decrypted and structured text data stored in the database. The server logs this data in association with the user's identifier.

### Step 5:

Server performs semantic analysis on the stored text using natural language processing (NLP) modules. The input is the user's text data from Step 4; the output is a set of structured semantic components such as key entities, sentence structure, and context. The server breaks down the text into tokens, tags parts of speech, and identifies key meanings.

### Step 6:

Server constructs a prompt sentence for a generative AI model based on the semantic analysis, user attributes, and session context. The input is the semantic structure from Step 5 together with user profile data; the output is a prompt sentence formatted for the generative AI model. The server may include cues about preferred colors, font size, or content focus in the prompt.

### Step 7:

Server invokes the generative AI model, providing the prompt sentence as input, and receives visual information data (such as an image or video) as output. The input is the prompt sentence from Step 6; the output is machine-generated visual content. The server interacts with a trained generative adversarial network, diffusion model, or equivalent.

### Step 8:

Server customizes the generated visual content according to the user's attribute information. The input is the visual content from Step 7 and the user's profile; the output is a personalized image or video. The server adjusts colors, font sizes, layouts, or overlays accessibility features using image processing libraries.

### Step 9:

Terminal collects biometric data, such as a facial image or audio recording of the user, and transmits it to the server for emotion analysis. The input is real-time biometric data; the output is an encrypted transmission to the server. The terminal uses the device's camera or microphone to capture the user's current state.

### Step 10:

Server analyzes the user's emotional state using the biometric data. The input is the biometric data from Step 9; the output is an emotional classification, such as “stressed,” “relaxed,” or “focused.” The server applies an emotion analysis engine or artificial intelligence classifier to the input data.

### Step 11:

Server optimizes the personalized visual content based on the user's emotional state. The input is the personalized image/video from Step 8 and the emotion analysis result from Step 10; the output is an emotion-adapted visual content file. The server may soften colors, simplify layouts, or increase contrast to reduce stress or enhance engagement.

### Step 12:

Server transmits the optimized visual content to the user's display device. The input is the optimized content from Step 11; the output is a data stream sent to the terminal. The server may use real-time API calls or data streaming technologies.

### Step 13:

Terminal receives, decodes, and displays the optimized visual content. The input is the data stream from Step 12; the output is the visual content rendered on the display device. The terminal uses display drivers and a media rendering module to present the image or video via screen, AR overlay, or VR environment.

### Step 14:

User views and interacts with the tailored and emotionally optimized visual content on the display device. The input is the rendered content from Step 13; the output is the user's comprehension, improved accessibility, and engagement with the information.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

There are significant challenges for individuals, particularly those with dyslexia or other visual processing difficulties, in comprehending textual information displayed digitally or physically. Conventional systems often fail to provide personalized, easily understandable visual content that dynamically adapts to both the user's personal visual preferences and real-time emotional state. As a result, such users experience frustration, misinterpretation, or difficulty accessing important content in daily tasks such as online shopping or information retrieval.

The specific processing by the specific processing unit 290 of the data processing device 12 in Application Example 2 is realized by the following means.

The present invention provides a server including a processor configured to obtain text data, analyze the obtained text data for meaning and structure using a natural language analysis model, generate visual content utilizing a generative artificial intelligence model, adjust the generated visual content based on user attribute information, recognize a user's emotional state using an emotion analysis unit, optimize the visual content in accordance with the emotional state, and transmit the adjusted and optimized content to a user's display device, such as an augmented reality or virtual reality device. This enables users to access, comprehend, and interact with information in a manner that is both visually and emotionally tailored to their individual needs, thereby enhancing usability, comfort, and understanding.

The term “text data” refers to information in the form of characters, words, sentences, or paragraphs, which may be presented electronically or captured from physical media for further processing.

The term “natural language analysis model” refers to a machine learning or artificial intelligence model that is capable of interpreting, parsing, and extracting meaning and structure from human language input.

The term “generative artificial intelligence model” refers to an artificial intelligence system, including neural networks or deep learning models, that generates new data, such as images or videos, from given inputs such as text or other contextual information.

The term “visual content” refers to any information visually presented as an image, graphic, video, or other format distinguishable by sight, generated to represent or embody input data.

The term “user attribute information” refers to data describing personal characteristics, preferences, or accessibility requirements of a user, such as visual impairments, color or font preferences, or interface customization settings.

The term “emotion analysis unit” refers to a component or software function configured to detect and determine a user's emotional state based on input data, including but not limited to facial expressions, voice features, or behavioral cues.

The term “display device” refers to any hardware capable of presenting visual content to a user, such as flat panel displays, augmented reality devices, virtual reality devices, or head-mounted displays.

The term “optical character recognition processing technology” refers to any method or algorithm that converts images of textual content into machine-readable text data.

One embodiment of the present invention may be implemented as a system including a server, a terminal device, and a display device. The server includes at least a processor, memory, and network communication interface. The terminal device refers to a general information processing device such as a smartphone, tablet, or personal computer, which can acquire text data by capturing images and transmitting the text data to the server. The display device may include, for example, a flat-panel display, augmented reality glasses, or virtual reality headset.

The terminal is configured to obtain images containing text data using a camera function. Image acquisition may be accomplished by the user manually capturing a photograph of textual content, such as a product label, an instruction manual, or a web page displayed on a screen. The terminal applies optical character recognition (OCR), such as by using Tesseract OCR software, to convert the image into machine-readable text data.

The terminal transmits the extracted text data, together with user metadata such as profile information and optionally emotion-related data (e.g., facial images or voice data), to the server through a secure communication channel, such as HTTPS.

The server is configured to analyze the received text data by employing a natural language analysis model such as BERT or GPT. The server parses the text, determines meaning and structure, and recognizes key elements for information extraction and contextual understanding.

The server generates a prompt sentence that instructs a generative artificial intelligence model, such as a generative adversarial network (GAN), to create visual content that visually represents the information included in the text. For example, if the original text is a product description, the server may construct the prompt sentence as follows:

“Make an easy-to-understand illustration for a user with dyslexia: ‘This chair is made from oak wood. It supports up to 120 kg.’ Use large fonts and gentle blue tones.”

The generative AI model receives the prompt and produces visual content, which may include illustrations, graphics, or simplified videos tailored for the target user's needs.

Using user attribute information, such as preferred color schemes, font sizes, or accessibility requirements, the server customizes the generated visual content. The server may also apply emotion recognition techniques using an emotion analysis unit that analyzes the user's facial images or voice data. Based on the recognized emotional state, the server further optimizes the visual content, such as by applying calming colors or simplifying visual elements if the user is experiencing stress.

The server transmits the adjusted and optimized visual content to the user's display device, which may be an augmented reality or virtual reality device, or a standard monitor. The terminal or display device then presents this content to the user, enabling them to access and understand the information in a visually and emotionally tailored manner.

As a concrete example, when a user wishes to understand the product description of an online shopping item, the user uses their smartphone camera to capture the label. The terminal extracts the text “This chair is made from oak wood. It supports up to 120 kg.” using OCR, and transmits it to the server. The server analyzes the text, generates a clear image showing a wooden chair with key features summarized, adjusts colors and fonts according to the user's profile, detects the user's stress through facial analysis and applies a calming blue color to the image, and finally delivers the adjusted image to the user's AR glasses, where it is displayed in real time.

In summary, the present embodiment utilizes commonly available hardware and software components, such as smartphones, AR/VR displays, Tesseract OCR, BERT or GPT language models, generative adversarial networks, and emotion recognition modules, to realize a system that provides visually optimized and emotionally adaptive information presentation. Users receive prompt, accessible, and comprehensible visual content, improving their daily life experiences in contexts such as online shopping and general information retrieval.

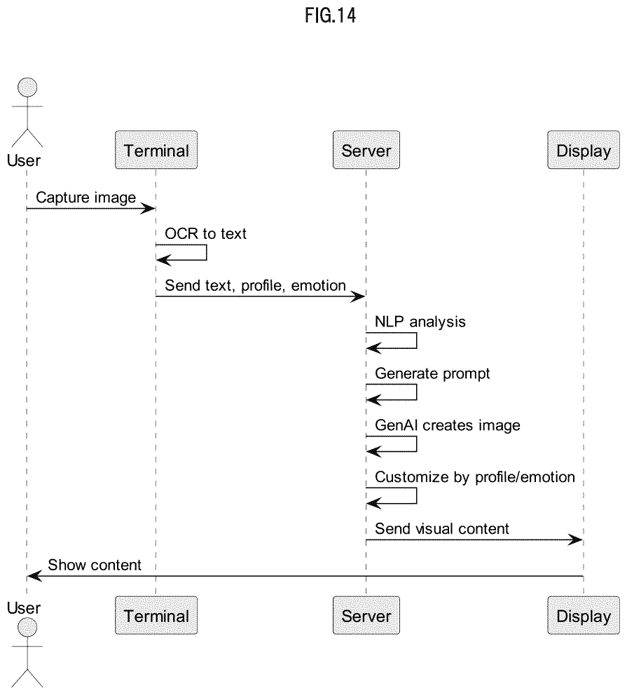

The following describes the processing flow using FIG. 14.

### Step 1:

User uses a terminal device, such as a smartphone or tablet, to capture an image containing the desired text information. The input is a physical object or screen displaying text, and the output is a digital image containing the text, acquired by the terminal's camera application.

### Step 2:

Terminal processes the captured image using an optical character recognition (OCR) engine, such as Tesseract. The input is an image file, and the terminal detects regions containing text, recognizes the characters, and outputs a machine-readable text string as the result.

### Step 3:

Terminal collects any relevant user profile information, such as visual preferences and accessibility settings, and may prompt User to optionally provide emotional data, such as a facial photo or voice recording. The input is user input or sensor data, and the output is a compiled data package containing text data, profile information, and potentially emotion data.

### Step 4:

Terminal transmits the compiled data package (text string, profile information, and emotion data) to the server via a secure network connection. The input is the compiled data package, and the output is successful data transmission to the server.

### Step 5:

Server analyzes the received text using a natural language analysis model, such as BERT or GPT. The input is the text string, and the server parses and segments the text, extracting semantic meaning and key elements. The output is structured data representing the main concepts, summaries, or extracted features of the text.

### Step 6:

Server generates a prompt sentence for a generative artificial intelligence model based on the structured data. The input is the structured semantic information, and the output is a formatted prompt string, such as: “Make an easy-to-understand illustration for a user with dyslexia: ‘This chair is made from oak wood. It supports up to 120 kg.’ Use large fonts and gentle blue tones.”

### Step 7:

Server uses a generative AI model, such as a generative adversarial network, to produce visual content based on the prompt sentence. The input is the prompt sentence and model parameters, and the output is newly generated visual content, such as an image or simple video illustrating the key features.

### Step 8:

Server customizes the generated visual content according to user attribute information. The input is the user's profile and the visual content, and the server modifies elements such as color schemes, font size, or arrangement to align with the user's needs, outputting a modified and individualized version of the visual content.

### Step 9:

Server analyzes the provided emotion data using an emotion analysis unit to recognize the user's emotional state. The input is the emotion data (facial image, voice data), and the output is a determination of the user's current emotion, such as stress, confusion, or calmness.

### Step 10:

Server further optimizes the visual content based on the recognized emotional state. The input is the recognized emotion and the current visual content, and the server adjusts design elements, such as applying calming color tones or simplifying layout, and outputs the fully customized content.

### Step 11:

Server transmits the fully customized and optimized visual content to the user's display device, such as AR glasses, a VR headset, or a standard display. The input is the optimized visual content, and the output is data sent to the device.

### Step 12:

Terminal or visual device receives the visual content and displays it to User. The input is the received visual content file, and the output is the real-time presentation of visual information on the display device, allowing User to easily understand the original text content in a form optimized for their preferences and emotional state.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

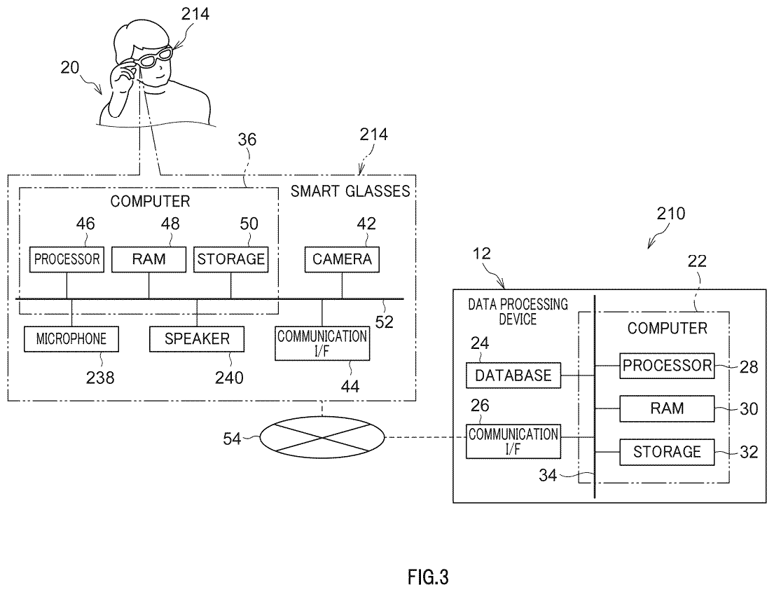

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

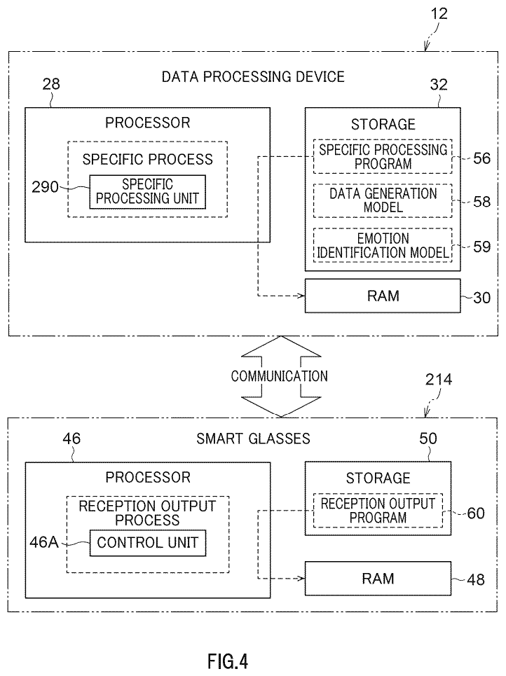

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

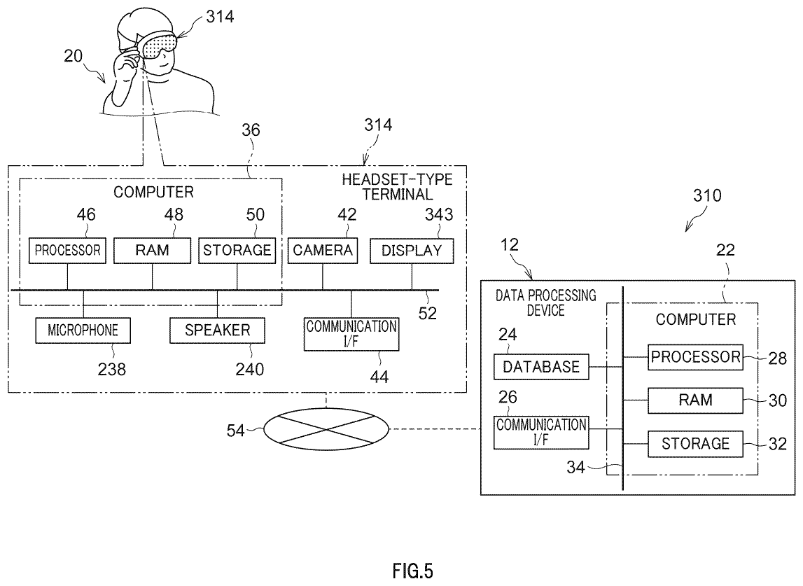

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

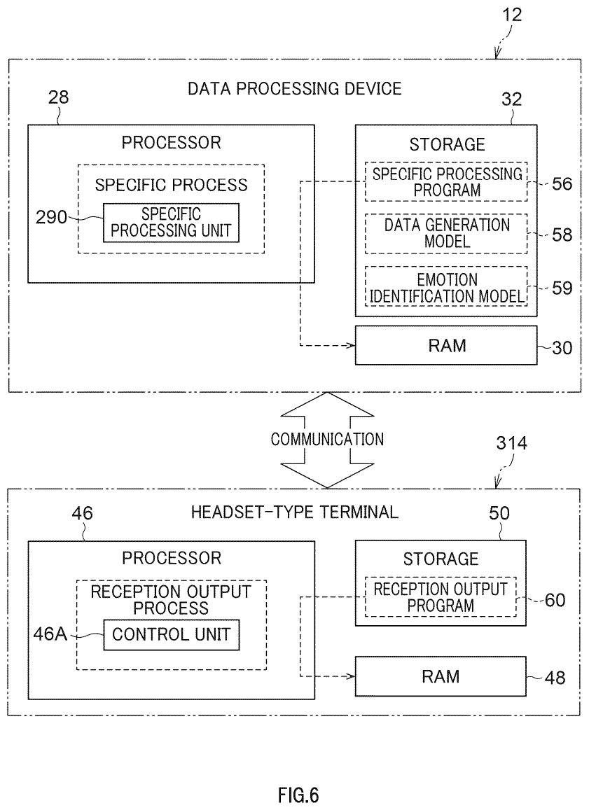

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

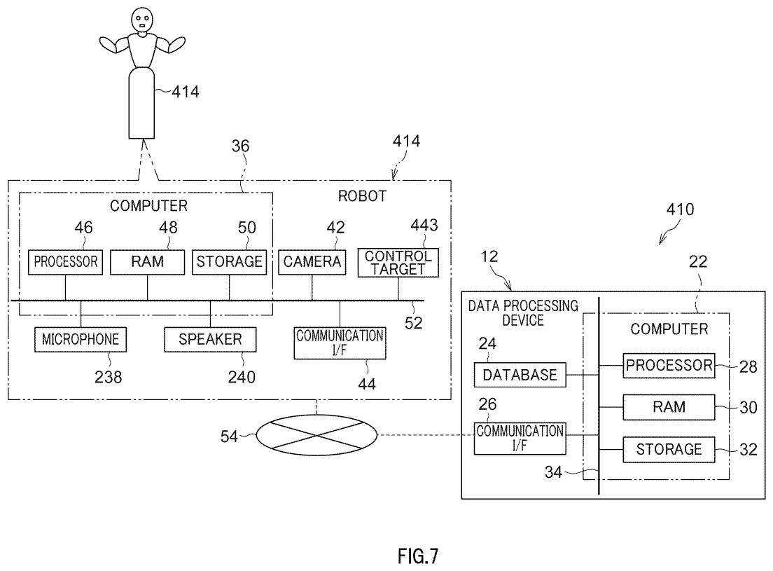

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

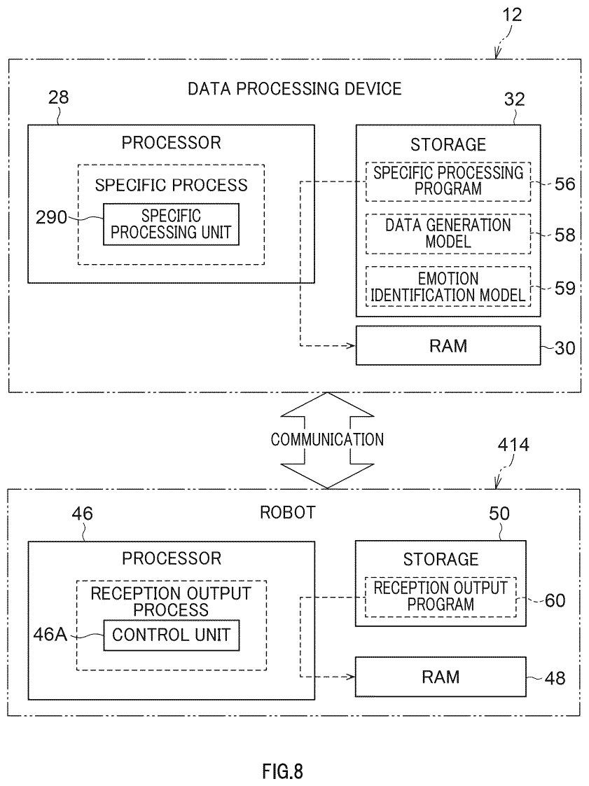

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

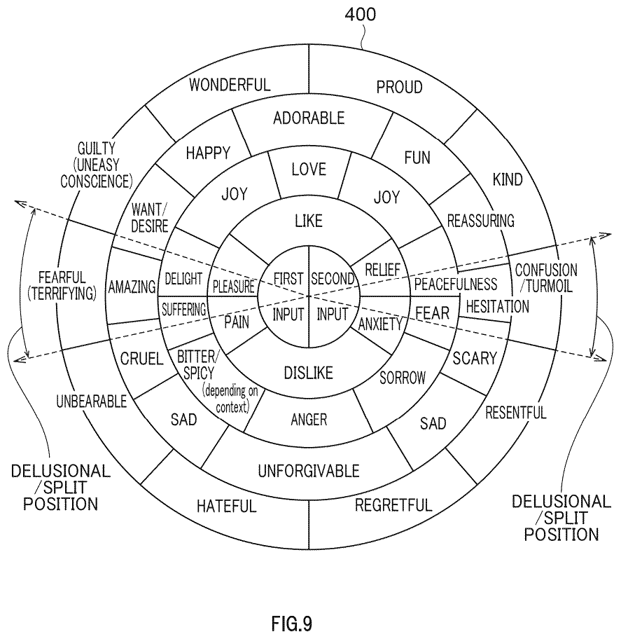

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

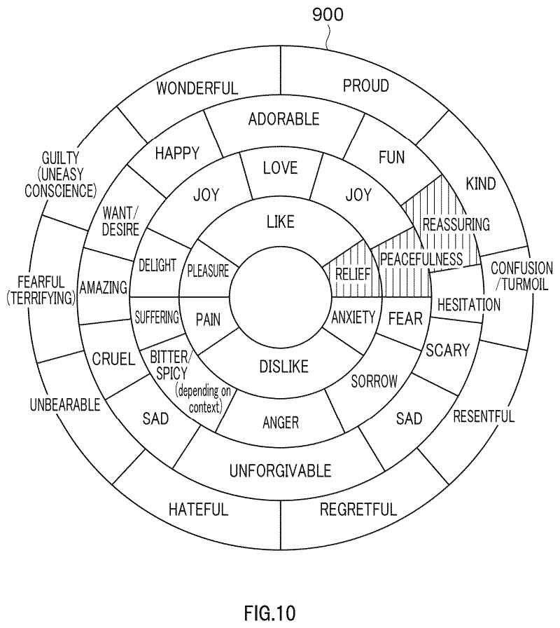

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system including a processor,
wherein the processor is configured to:
acquire data information,
perform optical recognition processing on the acquired data information to extract character string data and conduct syntactic analysis on the extracted character string data,
convert the syntactically analyzed character string data into visually recognizable visual representation data using a generative artificial intelligence model,
adjust the visual representation data based on user information regarding components, display format, color scheme, emphasis, and other display attributes,
transmit the adjusted visual representation data to an information presentation device, and
generate and adjust a prompt sentence for input to the generative artificial intelligence model.

### (Supplementary 2)

The system according to supplementary 1, wherein the processor is configured to use the information presentation device as an augmented reality display device or a virtual reality display device.

### (Supplementary 3)

The system according to supplementary 1, wherein the processor is configured to use optical recognition processing technology for acquiring data information.

### Application Example 1

### (Supplementary 1)

A system including a processor,
wherein the processor is configured to:
acquire data using an information acquisition apparatus,
extract character data from the acquired data,
analyze the meaning of the extracted character data using a natural language processing model,
generate visual data by inputting a generation instruction sentence to a generative AI model based on the analyzed character data and user attribute information,
individually optimize the generated visual data in accordance with the user attribute information or user state information, and
transmit and present the optimized visual data to a display device.

### (Supplementary 2)

The system according to supplementary 1, wherein the processor is configured to cause the display device to be an augmented reality device or a virtual reality device.

### (Supplementary 3)

The system according to supplementary 1, wherein the processor is configured to use optical character recognition technology for data acquisition.

### Example 2

### (Supplementary 1)

A system including a processor,
wherein the processor is configured to:
acquire character information;
extract and digitize the acquired character information through a recognition process;
analyze the digitized character information through a semantic analysis process;
convert, based on the analysis result, the character information into visual information data by using a generative artificial intelligence model in accordance with a prompt sentence;
individually adjust the visual information data based on user attribute information;
   analyze an emotional state of a user based on facial information or voice information of the user;
optimize the visual information data according to the result of the emotional state analysis; and
transmit the optimized visual information data to a display device of the user.

### (Supplementary 2)

The system according to supplementary 1, wherein the display device includes an augmented reality device or a virtual reality device.

### (Supplementary 3)

The system according to supplementary 1, wherein the processor is configured to acquire the character information by using an optical recognition process.

### Application Example 2

### (Supplementary 1)

A system including a processor,
wherein the processor is configured to:
obtain text data,
analyze the obtained text data to determine meaning and structure using a natural language analysis model,
generate visual content based on the analysis by using a generative artificial intelligence model,
adjust the visual content based on user attribute information,
recognize a user's emotional state using an emotion analysis unit and optimize the visual content in accordance with the emotional state, and
transmit the adjusted and optimized visual content to a user's display device.

### (Supplementary 2)

The system according to supplementary 1, wherein the processor is configured to transmit the visual content to an augmented reality device or a virtual reality device as the user's display device.

### (Supplementary 3)

The system according to supplementary 1, wherein the processor is configured to obtain the text data using an optical character recognition processing technology.

What is claimed is:

1. A system comprising a processor,
wherein the processor is configured to:
acquire text information;
convert the acquired text information into an image or a video;
customize the image or video based on user profile information; and
transmit the customized image or video to a user's visual device.

2. The system according to claim 1, wherein the visual device is an augmented reality (AR) device or a virtual reality (VR) device.

3. The system according to claim 1, wherein the means for acquiring text information utilizes optical character recognition (OCR) technology.
